(19) United States
(12) Patent Application Publication
(10) Pub. No.: US 2013/0161293 A1
(43) Pub. Date: Jun. 27, 2013

(54) WIRE ELECTRIC DISCHARGE MACHINE DISSOLVING INTERT GAS IN MACHINING FLUID AND WIRE ELECTRIC DISCHARGE MACHINING METHOD USING THE SAME

(71) Applicant: FANUC Corporation, Minamitsuru-gun (JP)

(72) Inventors: Tomoyuki FURUTA, Yamanashi (JP); Akiyoshi KAWAHARA, Minamitsuru-gun (JP)

(73) Assignee: FANUC Corporation, Minamitsuru-gun (JP)

(21) Appl. No.: 13/659,121

(22) Filed: Oct. 24, 2012

(30) Foreign Application Priority Data
Dec. 27, 2011 (JP) 2011-285807

(51) Int. Cl. B23H 1/00

(52) U.S. Cl. 219/69.11

(57) ABSTRACT

A wire electric discharge machine machines a workpiece immersed in an electrically conductive water-based machining fluid stored in a machining vessel. An inert gas dissolver is provided in the wire electric discharge machine to pressurize the machining fluid, dissolve an inert gas into the pressurized machining fluid, and depressurize the machining fluid, such that wire discharge machining is carried out in the machining fluid containing the inert gas dissolved therein.

### BACKGROUND OF THE INVENTION

1. Field of the Invention

The present invention relates to a wire electric discharge machine dissolving in a machining fluid an inert gas requiring no running cost and capable of preventing the corrosion of workpieces and a wire electric discharge machining method using this wire electric discharge machine.

2. Description of the Related Art

There are two types of machining fluids used in wire electric discharge machines: water-based fluids and oil-based fluids. In an oil-based machining fluid, in which electrolytic action hardly occurs, the galvanic corrosion of workpieces does not occur, but the machining speed cannot be increased in the rough machining stage because a high machining energy cannot be applied, compared with a water-based machining fluid. The oil-based machining fluid has a critical demerit that it can catch fire when a discharging point is brought into contact with air.

On the other hand, a water-based machining fluid has a merit that, since water has a higher cooling effect due to a higher specific heat and a higher heat of vaporization than oil, a higher machining energy can be applied and a machining speed several times higher than the oil-based machining oil can be achieved in the rough machining stage. The water-based machining fluid has, however, a demerit that the workpiece immersed in it for a long time corrodes due to electrolytic action. Especially, if a workpiece made of an ultrahard material containing cobalt as the binder is immersed in a water-based machining fluid, the cobalt that is used as the binder flows out of the machined surfaces and embrittles the workpiece, resulting in a shorter useful life of the workpiece made of the ultrahard material.

To solve this problem, Japanese Patent Application Laid-Open No. 5-220618 discloses a technique for preventing the corrosion of workpieces by providing a corrosion preventing electrode facing the workpiece, applying a voltage across the workpiece and the corrosion preventing electrode from a minute voltage power supply, with the workpiece being negative pole, in order to corrode the corrosion preventing electrode, instead of the workpiece.

The technique disclosed in Japanese Patent Application Laid-Open No. 5-220618 achieves substantially no anticorrosive effect on the workpiece surfaces remote from the corrosion preventing electrode because the effect weakens as the distance from the corrosion preventing electrode increases. It also has demerits that the metal ions eluted from the corrosion preventing electrode adhere to the workpiece surfaces, deteriorating the shape accuracy of the workpiece and/or producing corrosion and/or coloring of the workpiece, and that the corrosion preventing electrode is consumable and requires running cost.

Japanese Patent Application Laid-Open No. 2002-301624 discloses a technique for preventing the corrosion of workpieces of iron-based metal material in an aqueous machining fluid by removing corrosive ions using an anion exchange resin in which one or more ions from among carbonate ion, hydrogencarbonate ion and hydroxide ion, and a nitrite ion are immobilized.

The technique disclosed in Japanese Patent Application Laid-Open No. 2002-301624 has an anticorrosive effect on iron-based materials, but not on non-iron-based materials such as ultrahard material. In addition, the anion exchange resin is consumable and requires running cost.

Japanese Patent Application Laid-Open No. 2011-20185 discloses a technique for preventing the corrosion of workpieces due to corrosive factors such as water and oxygen by forming a passivation film on the workpiece surfaces by controlling the pH of the machining fluid using a pH sensor, H⁺ type ion exchange resin, and OH⁻ type ion exchange resin such that the workpieces of magnetic material such as iron-based material or ultrahard material become basic, while the workpieces of nonmagnetic material such as copper-tungsten based material become acidic.

There is a problem with the technique disclosed in Japanese Patent Application Laid-Open No. 2011-20185, however, that, as generally known, it is difficult to measure accurately the pH value since the pH sensor is influenced by heavy metal ions in a fluid containing a large quantity of heavy metal ions produced by electric discharge machining such as the machining fluid in a wire electric discharge machine. If the pH value cannot be measured accurately, the pH of the machining fluid may possibly become strongly basic or acidic and produce damage to the skin or vision of the operator when he/she unintentionally touches such a machining fluid. This technique also has a demerit that the H⁺ type and OH⁻ type ion exchange resins are consumable and require running costs.

Japanese Patent Application Laid-Open No. 2010-12592 discloses a technique for preventing corrosion or coloring of a workpieces due to adherence of metal ions to the workpiece, by adding adenin in the machining fluid to make metal ions in the machining fluid complex, while biasing an average voltage to be applied at a machining gap.

The technique disclosed in Japanese Patent Application Laid-Open No. 2010-12592 substantially has no anticorrosive effect on the workpiece surfaces remote from a guide because the anticorrosive effect obtained by biasing the average voltage weakens as the distance from the guide increases. Although it is described that adenin prevents the adhesion of eluted metal ions, it does not work well in this case to prevent the corrosion of cobalt contained in the ultrahard material because cobalt may be very sensitive to oxidation by oxygen dissolved in the machining fluid. It also has a demerit that adenin is consumable and requires running cost.

Japanese Patent Application Laid-Open No. 5-169318 discloses a technique relying on a membrane vacuum deaerator to remove the dissolved oxygen and carbon dioxide from machining fluid and thereby prolong the useful life of ion exchange resins. Japanese Patent Application Laid-Open No. 6-319905 discloses a technique for preventing corrosion of machined surfaces by separating the dissolved gases from the machining fluid using a membrane vacuum deaerator during wire discharge machining. Both techniques rely on membrane vacuum deaerators to separate the dissolved oxygen from the machining fluid. Such a membrane vacuum deaerator is larger in scale and requires a higher equipment cost than the inert gas dissolution method used in the present invention. Those techniques are impractical because the hollow fiber membrane module is typically consumable and requires periodical replacement and, when a liquid containing a large quantity of heavy metal ions such as the machining fluid used for wire discharge machining flows through the hollow fiber membrane module, the hollow fiber membrane module deteriorates quite rapidly and requires frequent replacement, requiring a large amount of time and labor for replacement as well as a very high running cost.

The conventional techniques as described above have problems that the effect is achieved only near the electrodes, that the material is limited to an iron-based material, and that running cost is required.

### SUMMARY OF THE INVENTION

An object of the present invention is to provide a wire electric discharge machine and a wire electric discharge machining method capable of removing dissolved oxygen and thus preventing the corrosion of workpieces by dissolving a running cost-free inert gas in the machining fluid in the wire electric discharge machine.

The wire electric discharge machine according to the present invention includes a machining fluid storage tank for storing a water-based electrically conductive machining fluid and a machining vessel for accommodating a workpiece therein, and machines the workpiece immersed in the machining fluid that is supplied from the machining fluid storage tank and stored in the machining vessel. This wire electric discharge machine further includes an inert gas dissolver for pressuring the machining fluid, dissolving the inert gas in the pressurized machining fluid, and then depressurizing the machining fluid.

The inert gas dissolver may include a pressurizer for pressurizing the machining fluid, a mixer for mixing the inert gas in the pressurized machining fluid or a pressure mixer for pressurizing the machining fluid while mixing the inert gas in the machining fluid, and a depressurizer for depressurizing the machining fluid to its original pressure after mixing. A check valve may also be provided to prevent the back-flow of the machining fluid to the inert gas injection channel of the mixer or pressure mixer. The inlet for injecting the inert gas into the machining fluid in the mixer or pressure mixer may have many perforations.

The wire electric discharge machine may further include a pump for forcing the machining fluid stored in the machining fluid storage tank to flow to the machining vessel in which the workpiece is immersed. In this case, the inert gas dissolver may be disposed on the channel between the pump and the machining vessel.

The wire electric discharge machine may further include an inert gas dissolution-dedicated pump for forcing the machining fluid to flow from the machining fluid storage tank or from the machining vessel to the inert gas dissolver. The inert gas dissolution-dedicated pump may also force the machining fluid to flow from the machining fluid storage tank or from the machining vessel to the inert gas dissolver, and force the treated machining fluid to flow back to the machining fluid storage tank or to the machining vessel.

The wire electric discharge machine may further include a dissolved oxygen measuring instrument for measuring dissolved oxygen in the machining fluid such that, when the dissolved oxygen measuring instrument detects a decrease of the quantity of dissolved oxygen in the machining fluid to a target value, the inert gas dissolver is stopped.

The wire electric discharge machine may also include, in addition to the inert gas dissolver, a deoxidant injector for injecting deoxidant into the machining fluid.

The wire electric discharge machine may further include an ion exchange resin to keep the specific resistance of the machining fluid at a value not less than 2×10⁵ Ωcm.

The wire electric discharge machine may further include a supply channel for supplying the machining fluid from the machining fluid storage tank through upper and lower nozzles and may use this supply channel to allow the machining fluid to flow through the upper and lower nozzles during non-machining periods.

The wire electric discharge machine may further include a sacrificial electrode attached in an electrically insulated manner to at least one of the upper and lower guide blocks stretching a wire electrode therebetween and an auxiliary power supply unit for applying a voltage across the sacrificial electrode serving as one electrode and the workpiece serving as the other electrode. And the auxiliary power supply unit applies a voltage such that an average voltage at the upper and/or lower guide blocks or at the sacrificial electrode with respect to the workpiece becomes a positive value.

The wire electric discharge machine may use nitrogen as the inert gas.

A wire electric discharge machining method according to the present invention is a method for machining a workpiece immersed in an electrically conductive water-based machining fluid stored in a machining vessel, including the steps of pressuring the machining fluid, dissolving an inert gas in the machining fluid, dissolving the inert gas into the machining fluid, depressurizing the machining fluid containing the inert gas dissolved therein to an original pressure thereof, and carrying out wire discharge machining within the machining vessel storing the machining fluid containing the inert gas dissolved therein.

The present invention can provide a wire electric discharge machine and a wire electric discharge machining method capable of removing dissolved oxygen and thus preventing the corrosion of workpieces stably by dissolving a running cost-free inert gas in the machining fluid in the wire electric discharge machine.

### BRIEF DESCRIPTION OF THE DRAWINGS

These and other objects and features of the present invention will become apparent from the following description of embodiments with reference to the appended drawings, in which:

FIG. 1 illustrates a first embodiment of a wire electric discharge machine according to the present invention including a pump for forcing a machining fluid stored in a machining fluid storage tank to flow to a machining vessel in which a workpiece is immersed, and an inert gas dissolver disposed between the pump and the machining vessel;

FIG. 2 illustrates a second embodiment of a wire electric discharge machine according to the present invention including an inert gas dissolution-dedicated pump for forcing a machining fluid to flow to a machining fluid storage tank or to flow from a machining vessel to an inert gas dissolver, and to flow a treated machining fluid back to the machining fluid storage tank or to the machining vessel;

FIG. 3 illustrates an example of inert gas dissolver for use in the wire electric discharge machine in FIG. 1 or 2;

FIG. 4 illustrates an example of dissolved oxygen measuring instrument in the machining vessel shown in FIG. 2; and

FIG. 5 illustrates an example of implementation of a sacrificial electrode and an auxiliary power supply unit.

### DETAILED DESCRIPTION OF THE PREFERRED EMBODIMENTS

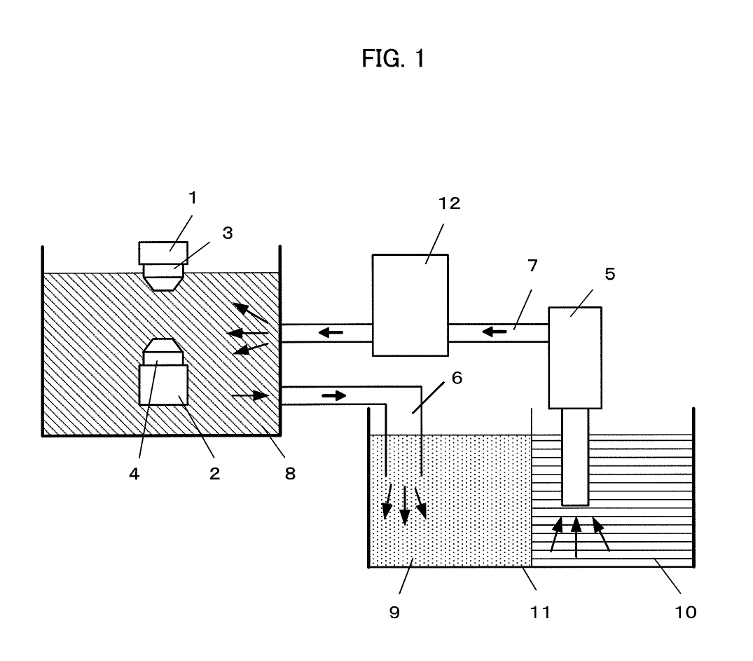

A first embodiment of a wire electric discharge machine according to the present invention will now be described with reference to FIG. 1. This wire electric discharge machine includes a pump for forcing a machining fluid stored in a machining fluid storage tank to flow to a machining vessel in which a workpiece is immersed, and an inert gas dissolver provided between the pump and the machining vessel.

In the wire electric discharge machine according to this embodiment, the pump is usually used to constantly force the circulating fluid to flow through the machining vessel in order to maintain the fluid level during non-machining periods. This pump for forcing the circulating fluid to flow can also be used to force the machining fluid to flow to the inert gas dissolver, so that the inert gas dissolver can be configured without a dedicated pump.

The wire electric discharge machine includes a machining vessel 8 in which a table (not shown) is placed to carry a workpiece (not shown) thereon. The machining vessel 8 stores an electrically conductive water-based machining fluid and has a machining area in which the workpiece immersed in the machining fluid is machined. A wire electrode (not shown) is stretched between an upper guide block 1 and a lower guide block 2, and radio frequency pulses for electric discharge machining are applied to the stretched wire electrode to generate electric discharges between the wire electrode and the workpiece (machining gap) to machine the workpiece. An upper nozzle 3 is attached to the upper guide block 1, while a lower nozzle 4 is attached to the lower guide block 2.

The machining fluid is supplied to and stored in the machining vessel 8. The machining fluid in the machining vessel 8 contains machining debris produced by electric discharge machining and is arranged so as to flow through a drain duct 6 to a waste water vessel 9. The machining fluid containing machining debris collected and stored in the waste water vessel 9 is filtered through a machining debris removing means including a filter (not shown) or the like and then supplied to a freshwater vessel 10. The combination of the waste water vessel 9 and the freshwater vessel 10 will be referred to hereinafter as a machining fluid storage tank 11. The machining fluid stored in the freshwater vessel 10 is pumped by a circulating pump 5 and supplied through a circulating water pipe 7 to the machining vessel 8. An inert gas dissolver 12 is mounted on the circulating water pipe 7.

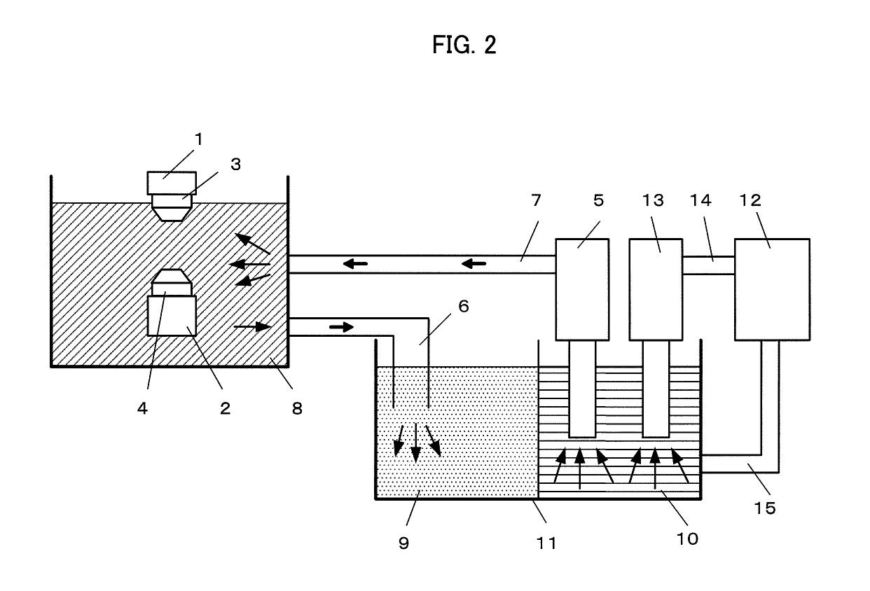

Next, a second embodiment of a wire electric discharge machine according to the present invention will be described with reference to FIG. 2. This wire electric discharge machine includes an inert gas dissolution-dedicated pump for forcing a machining fluid to flow to a machining fluid storage tank or to flow from a machining vessel to an inert gas dissolver, and to flow a treated machining fluid back to the machining fluid storage tank or to the machining vessel.

The machining fluid stored in the freshwater vessel 10 is pumped out by an inert gas dissolution-dedicated pump 13 and is supplied through an inert gas dissolver water supply pipe 14 to an inert gas dissolver 12. An inert gas is dissolved in the machining fluid by the inert gas dissolver 12 and this machining fluid is then fed through the inert gas dissolver drain pipe 15 back to the freshwater vessel 10.

The wire electric discharge machine shown in FIG. 2 (second embodiment) will be more suitable than the machine shown in FIG. 1 (first embodiment) when the flow rate of the machining fluid in the wire electric discharge machine is insufficient due to an increased channel resistance to the circulating fluid because the machining fluid is fed to the inert gas dissolver 12. The wire electric discharge machine shown in FIG. 2 (second embodiment) will be more suitable again than the machine in FIG. 1 (first embodiment) when the amount of dissolved oxygen can be further decreased by circulating the machining fluid only from the freshwater vessel 10 through the inert gas dissolver 12. If the inert gas dissolver 12 is not clogged by a machining fluid containing machining sludge, the inert gas dissolver 12 may be attached directly to the machining vessel 8 or waste water vessel 9, instead of to the freshwater vessel 10.

When oxygen dissolved in the water (machining fluid) was actually removed by circulating the machining fluid from the freshwater vessel 10 through the inert gas dissolver 12 in the wire electric discharge machine shown in FIG. 2, the dissolved oxygen in the machining vessel 8 was reduced from the saturated dissolved oxygen in water at 25° C., which is normally 8 milligrams/litter, to approximately 0.9 milligrams/litter.

In this state, wire discharge machining was carried out on a workpiece of ultrahard material using a brass wire electrode of 0.2 mm in diameter and subsequently the workpiece was left immersed in the machining fluid for about 60 hours. Then, through element analysis of the machined surfaces of the ultrahard material using a scanning electron microscope for analysis, it was confirmed that the corrosion of the cobalt as binder had scarcely occurred.

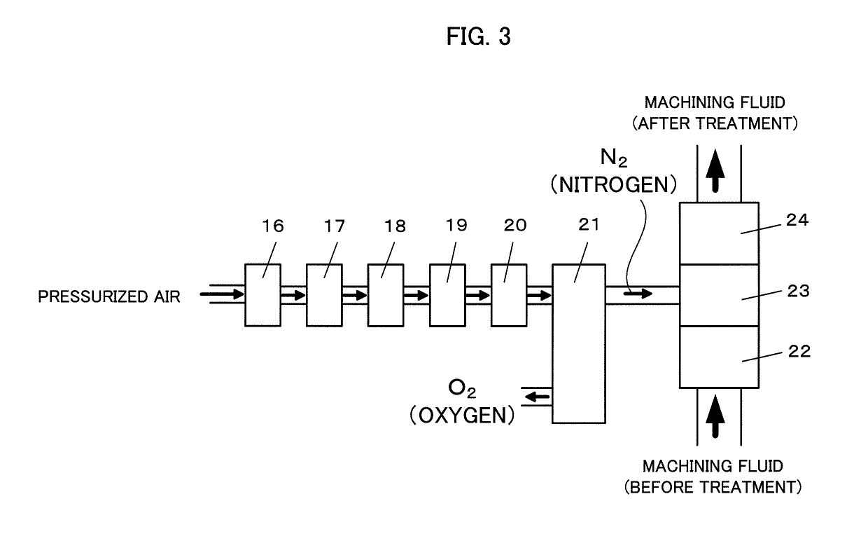

An example of inert gas dissolver used in the wire electric discharge machine shown in FIG. 1 or FIG. 2 will now be described with reference to FIG. 3.

The inert gas dissolver 12 illustrated in FIG. 3 uses a hollow fiber membrane-type nitrogen separation device 21 as a device for generating nitrogen gas as the inert gas (nitrogen generator), although a nitrogen gas container may be used instead. To prevent dust, oil, and/or moisture from entering the hollow fiber membrane-type nitrogen separation device 21 and degrading its nitrogen separation capacity, a pressurized air having passed an air filter 16, air mist filter 17, and air dryer 18 is used.

Although the performance of the hollow fiber membrane-type nitrogen separation device 21 generally does not degrade as long as an appropriate air is passed therethrough, the performance of the hollow fiber membrane-type nitrogen separation device 21 may degrade when the air filter 16, air mist filter 17, and air dryer 18 cannot completely eliminate dust, oil, or moisture. An air solenoid valve 20 may be arranged such that, when the dissolved oxygen decreases sufficiently, it can block air inflow and can thus prolong the useful life of the air filter 16, air mist filter 17, air dryer 18, and hollow fiber membrane-type nitrogen separation device 21. An air pressure regulating valve 19 can regulate the pressure of the pressurized air flowing into the hollow fiber membrane-type nitrogen separation device 21 to optimize the nitrogen partial pressure in the pressurized air.

On the other hand, the machining fluid is first pressurized by a machining fluid pressurizer 22 and is mixed in the pressurized state with nitrogen in a nitrogen mixer 23 for dissolution. Since nitrogen and oxygen conform to the law of physics that solubility is proportional to the partial pressure of component gas, pressurization enables the dissolution of a larger quantity of nitrogen. After the nitrogen is dissolved, the machining fluid can be depressurized by a machining fluid depressurizer 24 to eliminate the dissolved oxygen from the machining fluid.

The back-flow of the machining fluid to the hollow fiber membrane-type nitrogen separation device 21 can be prevented by providing a check valve (not shown) in the nitrogen injecting channel extending to the nitrogen mixer 23 that mixes the nitrogen gas as the inert gas, or to a pressure mixer (not shown) that pressurizes the machining fluid while mixing nitrogen or another inert gas in the pressurized machining fluid.

The nitrogen can be injected in the form of fine bubbles into the machining fluid by forming many perforations in the inlet for injecting the nitrogen as the inert gas into the nitrogen mixer 23 or pressure mixer described above. The large surface area of the nitrogen bubbles facilitates the dissolution of nitrogen in the machining fluid.

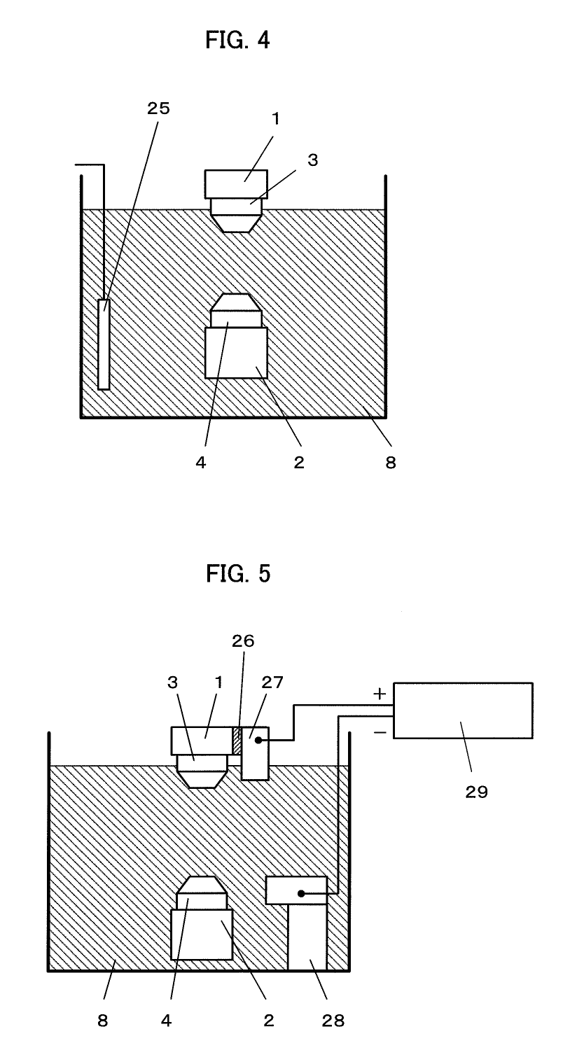

An example of implementation of a dissolved oxygen measuring instrument in the machining vessel 8 shown in FIG. 2 will be described with reference to FIG. 4.

A dissolved oxygen measuring instrument 25 is installed in the machining vessel 8 in which the workpiece is placed. When the quantity of dissolved oxygen in the machining vessel 8 decreases to a target value, an inert gas dissolution-dedicated pump 13 for the inert gas dissolver 12 is stopped and the air solenoid valve 20 in the inert gas dissolver 12 is closed. This can prolong the useful life of the inert gas dissolution-dedicated pump 13, air filter 16, air mist filter 17, air dryer 18, and hollow fiber membrane-type nitrogen separation device 21 for the inert gas dissolver 12 and save energy.

An additional means for complementing the inert gas dissolver 12 will now be described. This means may be used in a case where the inert gas dissolver 12 cannot achieve a sufficient corrosion prevention effect, for example, in a case where the workpiece is immersed in the machining fluid for three or more days.

The corrosion prevention effect can be enhanced by adding hydrazine, sodium sulfite, or other deoxidant (corrosion inhibitor) in at least one of the tank, from among the machining vessel 8, waste water vessel 9 and freshwater vessel 10 in FIG. 1. The deoxidant (corrosion inhibitor) is injected in units of a suitable amount by a deoxidant injector (not shown) into at least one of the tank, from among the machining vessel 8, waste water vessel 9 and freshwater vessel 10. A known device capable of injecting an appropriate amount of drug may be used as the deoxidant injector.

Alternatively, an ion exchange resin may be used to enhance the corrosion prevention effect by adjusting the specific resistance of the machining fluid to a value relatively higher than a specific resistance (7×10⁴ Ωcm-10×10⁴ Ωcm) typically used for machining, thus lowering the ion concentration in the machining fluid and thus suppressing the corrosion current.

The corrosion prevention effect can also be enhanced by forcing the machining fluid, which usually flows only during machining to cool the wire, to flow constantly through the upper and lower nozzles 3, 4 in FIG. 1 to prevent the machining fluid from staying on the workpiece surfaces while the workpiece is left immersed.

An example of implementation of a sacrificial electrode and an auxiliary power supply unit will now be described with reference to FIG. 5.

A sacrificial electrode 27 is attached in an electrically insulated manner to the upper guide block 1 or lower guide block 2 so as to serve as one electrode while the workpiece 30 accommodated in the machining vessel 8 serves as the other electrode, and an auxiliary power supply unit 29 is provided to apply voltage across these electrodes. The corrosion prevention effect for the workpiece 30 placed on the table 28 is enhanced by applying a voltage from the auxiliary power supply unit 29, such that an average voltage value at the upper and lower guide blocks 1, 2 or sacrificial electrode 27 with respect to the workpiece 30 becomes positive. The voltage applied by the auxiliary power supply unit 29 may have any waveform as long as the average voltage value at the upper and lower guide block 1, 2 or sacrificial electrode 27 with respect to the workpiece 30 is positive.

The above inert gas dissolver 12 provided in the wire electric discharge machine for machining a workpiece immersed in an electrically conductive water-based machining fluid stored in a machining vessel pressurizes the machining fluid, dissolves an inert gas in the pressurized machining fluid, and then depressurizes the machining fluid, such that wire discharge machining can be carried out while the inert gas is being dissolved in the machining fluid.

1. A wire electric discharge machine which includes a machining fluid storage tank for storing a water-based electrically conductive machining fluid and a machining vessel for accommodating a workpiece therein, and machines the workpiece immersed in the machining fluid that is supplied from the machining fluid storage tank and stored in the machining vessel, the wire electric discharge machine comprising:
an inert gas dissolver for pressurizing the machining fluid, dissolving an inert gas in the pressurized machining fluid, and then depressurizing the machining fluid.

2. The wire electric discharge machine according to claim 1, the inert gas dissolver comprising:
a pressurizer for pressurizing the machining fluid;
a mixer for mixing the inert gas into the pressurized machining fluid or a pressure mixer for pressurizing the machining fluid while mixing the inert gas into the machining fluid; and
a depressurizer for depressurizing the mixed machining fluid to its original pressure after mixing.

3. The wire electric discharge machine according to claim 2, further comprising a check valve for preventing back-flow of the machining fluid to an inert gas injecting channel of the mixer or pressure mixer.

4. The wire electric discharge machine according to claim 2, wherein an inlet for injecting the inert gas to the machining fluid in the mixer or pressure mixer has many perforations.

5. The wire electric discharge machine according to claim 1, further comprising:
a pump for forcing the machining fluid stored in the machining fluid storage tank to flow to the machining vessel in which the workpiece is immersed,
wherein the inert gas dissolver is disposed on a channel between the pump and the machining vessel.

6. The wire electric discharge machine according to claim 1, further comprising an inert gas dissolution-dedicated pump,
wherein the inert gas dissolution-dedicated pump forces the machining fluid to flow from the machining fluid storage tank or from the machining vessel to the inert gas dissolver.

7. The wire electric discharge machine according to claim 6, wherein the inert gas dissolution-dedicated pump forces the machining fluid to flow from the machining fluid storage tank or from the machining vessel to the inert gas dissolver, and further forces a treated machining fluid to flow back to the machining fluid storage tank or to the machining vessel.

8. The wire electric discharge machine according to claim 1, further comprising:
a dissolved oxygen measuring instrument for measuring dissolved oxygen in the machining fluid;
wherein, when the dissolved oxygen measuring instrument detects a decrease of the quantity of dissolved oxygen in the machining fluid to a target value, the inert gas dissolver is stopped.

9. The wire electric discharge machine according to claim 1, further comprising a deoxidant injector, in addition to the inert gas dissolver, for injecting deoxidant into the machining fluid.

10. The wire electric discharge machine according to claim 1, further comprising:
an ion exchange resin;
wherein the ion exchange resin is used to maintain a specific resistance of the machining fluid at a value not less than 2×10⁵ Ωcm.

11. The wire electric discharge machine according to claim 1, further comprising:
a supply channel for supplying the machining fluid from the machining fluid storage tank through upper and lower nozzles, wherein the supply channel is also used during non-machining periods to allow the machining fluid to flow through the upper and lower nozzles.

12. The wire electric discharge machine according to claim 1, further comprising:
a sacrificial electrode attached in an electrically insulated manner to at least one of the upper and lower guide blocks stretching a wire electrode therebetween, and an auxiliary power supply unit for applying a voltage across the sacrificial electrode serving as one electrode and the workpiece serving as the other electrode;
wherein the auxiliary power supply unit applies a voltage such that an average voltage value at the upper and lower guide block or sacrificial electrode with respect to the workpiece becomes positive.

13. The wire electric discharge machine according to claim 1, wherein nitrogen is used as the inert gas.

14. A wire electric discharge machining method for machining a workpiece immersed in an electrically conductive water-based machining fluid stored in a machining vessel, the method comprising:
pressurizing the machining fluid;
dissolving an inert gas in the pressurized machining fluid;
dissolving the inert gas into the machining fluid;
depressurizing the machining fluid containing the inert gas dissolved therein to an original pressure; and
carrying out wire discharge machining within the machining vessel storing the machining fluid containing the inert gas dissolved therein.
